(19) United States
(12) Patent Application Publication
(10) Pub. No.: US 2009/0201353 A1
(43) Pub. Date: Aug. 13, 2009

(54) METAL PLATE MEMBER, A FILTER, A LIQUID JET HEAD, A LIQUID JET APPARATUS AND A METHOD OF MANUFACTURING A METAL PLATE MEMBER

(75) Inventors: Shinichi Tonami, Sakata-shi (JP); Koichi Saito, Matsumoto (JP); Kenji Matsuyama, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/363,627

(22) Filed: Jan. 30, 2009

(30) Foreign Application Priority Data
Feb. 1, 2008 (JP) 2008-022441

(51) Int. Cl. B41J 2/175

(52) U.S. Cl. 347/93

(57) ABSTRACT

A metal plate member used as a filter for a liquid ejecting head or the like is a metal plate member with a plurality of through bores perforated therethrough, and on the surface thereof, pressure imprints by pressing a pressing member are formed.

### CROSS REFERENCES TO RELATED APPLICATIONS

The present application claims the priority based on Japanese Patent Application No. 2008-22441 filed on Feb. 1, 2008, and incorporates the application herein by reference.

### BACKGROUND OF THE INVENTION

1. Field of the Invention

The present invention relates to a metal plate member, a filter, and a liquid ejecting head equipped with the filter, a liquid ejecting apparatus, and a method of manufacturing a metal plate member.

2. Description of the Related Art

The present invention relates to a metal plate member with minute through holes bored through an extremely thin plate, a filter, and a liquid ejecting head equipped with the filter, a liquid ejecting apparatus, and a method of manufacturing a metal plate member, and specifically to a metal plate member in which generation of warping is suppressed after a bore punching process, a filter using the same, and a method of manufacturing a metal plate member, and particularly to those preferably applied to filters capturing foreign substances in a liquid supplied to a pressure generation chambers of a liquid ejecting head.

As one of the apparatuses that require capturing minute foreign substances (minute pieces, gas bubbles, and the like) in a liquid, there is a liquid ejecting apparatus that ejects various liquids, and among liquid ejecting apparatuses, ink jet recording apparatuses are widely used. An ink jet recording apparatus is equipped with an ink ejecting head that discharges ink droplets, which are liquid, from a plurality of nozzle openings. With the ink ejecting head, ink droplets are made to land on a surface of recording paper or the like, which is a medium, so as to print images and characters.

In an ink supply flow path provided in the ink ejecting head, a plate-shaped filter for removing foreign substances incorporated in the ink, in other words, minute pieces, such as synthetic resin remaining in the supply flow path for some reason, and gas bubbles, is arranged.

Given this factor, as such a filter forming of a large number of minute holes (for example, holes with a radius of 15 μm) by punching an extremely thin metal plate, for example, a stainless steel plate (SUS) of 10 to 20 μm in thickness has been considered. By making such an extremely thin metal plate with a large number of minute holes formed therethrough as a filter, it becomes possible to reduce pressure loss in order to sufficiently secure the flow rate of ink and moreover to provide a stable trapping function of foreign substances.

In spite of that, when trying to perforate a large number of minute through bores through an extremely thin metal plate member by a pressing process, there is a problem in that warping of the metal plate member after processing is generated.

General correction of such warping generated in a metal plate member is carried out by using a roller type leveler that exerts a stress so as to cancel out the stress generating the warping or by administering heat treatment, such as annealing in order to clear the residual stress.

However, for general roller type levelers, there is a restriction in terms of the thickness of metal plate members that they can be used on, and there is a problem in that warping of extremely thin metal plate member processed with a large number of minute through bores cannot be corrected. In addition, with roller type levelers, the straightening force exerted by the rollers is in one direction, and another straightening force in direction intersecting therewith has to be exerted in addition to that, and thus there is a problem in that a correction process of at least two steps is required.

In contrast, regarding the heat treatment, such as annealing, there are problems in that apparatuses, such as furnaces, are very expensive and also productivity is low due to the long processing time.

### SUMMARY OF THE INVENTION

Accordingly, the present invention has made in order to solve at least a part of the problems described above and can be achieved in modes or application examples given below.

As one mode in which the present invention may be applied, a metal plate member of the present invention is a metal plate member, including a plurality of through bores perforated therethrough, characterized in that pressure imprints are formed by pressing a pressing member against a surface of the metal plate member.

The features of the present invention other than the above and their objects should become clearly understood by reading the description of the present specification with reference to the attached drawings.

### BRIEF DESCRIPTION OF THE DRAWINGS

For a more complete understanding of the present invention and the advantages thereof, both the description below and the attached drawings should be referred to.

FIG. 1 is a schematic configuration diagram of an ink jet recording apparatus.

FIG. 2 is a sectional view of a main portion of an ink ejecting head.

FIG. 3 is a sectional view showing the entire ink ejecting head.

FIG. 4 (a) is a plan view of a filter, (b) is an enlarged plan view of a major portion of the filter, and (c) is an enlarged sectional view of the major portion of the filter.

FIG. 5 are illustrative drawings of bore processing for a filter.

FIG. 6 are a front view of a ball leveler, a plan layout drawing of spheres, and an illustrative drawing of a method of usage.

### DETAILED DESCRIPTION OF THE PREFERRED EMBODIMENTS

According to the description of the present specification and the illustration of the attached drawings, at least the following aspects are disclosed.

As one aspect of a liquid ejecting head, in order to achieve the above objects, a metal plate member of the present invention is a metal plate member, including a plurality of through bores perforated therethrough, characterized in that pressure imprints are formed by pressing a pressing member against a surface of the metal plate member.

According to the above configuration, by forming the pressure imprints due to plastic deformation under pressure in a surface of the metal plate member with a plurality of through bores perforated therethrough, the straightening force acts multidirectionally, and in this way, the residual stress while perforating the through bores is made uniform and the metal plate member can be corrected to be planar. Because of this, by determining what height (depth) and what pitch of the pressure imprints are acceptable for the metal plate member, correction of warping of the metal plate member with a plurality of through bores perforated therethrough can be carried out with certainty with a straightening process of one step, and also there is no requirement for large scale facilities as in the case of heat treatment.

In addition, the pressure imprints formed by the pressing member can be formed in pairs as lines of unevenness on front and back sides of the metal plate member to correct the warping by adding a straightening force uniformly and multidirectionally, and in addition, it is also possible to prevent generation of cracks.

In addition, a filter of the present invention is a filter that is disposed in a liquid flow path and that filters a liquid in the liquid flow path, and the filter is characterized in that pressure imprints due to plastic deformation under pressure are formed on a surface of a metal plate member with a plurality of through bores perforated therethrough.

According to the above configuration, by forming the pressure imprints on a surface of the metal plate member with a plurality of through bores perforated therethrough to make it into a filter, and by forming the pressure imprints with an action of the straightening force even when warping is developed in the metal plate member because of the perforation of the plurality of through bores, it is possible to make a filter corrected to be planar. In this way, pressure loss can be reduced and the flow rate of a liquid can be secured sufficiently, and yet still a liquid in a liquid flow path can be filtered in a stable state, so that reliability and productivity can be improved.

It should be noted that the pressure imprints mentioned above are desirably formed as pairs of lines of unevenness on front and back sides of the metal plate member, and the straightening force can be applied uniformly thereon.

In addition, a liquid ejecting head of the present invention includes the filter mentioned above.

According to the above configuration, it is possible to provide a liquid ejecting head with which pressure loss can be reduced and the flow rate of a liquid can be secured sufficiently and yet still a liquid in a liquid flow path can be filtered in a stable state and thus reliability and productivity can be improved.

Furthermore, a liquid ejecting apparatus of the present invention includes the liquid ejecting head mentioned above.

According to the above configuration, a highly reliable liquid ejecting apparatus can be provided.

In addition, a method of manufacturing a metal plate member of the present invention is a method of manufacturing a metal plate member with a plurality of through bores perforated therethrough, characterized by: setting the metal plate member between a leveler main body equipped with a plurality of convex pressing portions to which spheres protruding from a surface thereof are rollably provided and an elastic body supporting the metal plate member; and forming pressure imprints on a surface of the metal plate member by pressing the leveler main body towards the metal plate member in such state and also by moving relative to the metal plate member.

According to the above configuration, by setting the metal plate member between the leveler main body equipped with a plurality of convex pressing portions to which the spheres protruding from a surface thereof are rollably provided and the elastic body to press the spheres of the convex pressing portions and by forming the pressure imprints on the surface of the metal plate member, the metal plate member can be straightened to be planar.

In addition, a method of manufacturing a metal plate member of the present invention is a method of manufacturing a metal plate member with a plurality of through bores perforated therethrough, and may include: setting the metal plate member between a leveler main body equipped with a plurality of convex pressing portions to which spheres of a resin member protruding from a surface thereof are rollably provided and an elastic body supporting the metal plate member; and forming a plurality of pressure imprints on a surface of the metal plate member by pressing the leveler main body towards the metal plate member in such state and also by moving relative to the metal plate member.

According to the above configuration, by setting the metal plate member between the leveler main body equipped with a plurality of convex pressing portions to which the spheres of a resin member are rollably provided and the elastic body to press the spheres of a resin member to roll them, a plurality of pressure imprints can be formed on a surface of the metal plate member, and the concentration of stress in the metal plate member can be prevented with the convex pressing portions equipped with the spheres of a resin member and also the straightening force can be exerted uniformly and multidirectionally, so that it can prevent the generation of cracks and process to be planar.

Hereinafter, a preferred embodiment of the present invention is described with reference to the drawings. It should be noted that the embodiment described below is written as an example of the present invention, and not all of the described configuration has to be essential elements of the present invention.

### Best Embodiment

An embodiment is described below on the basis of the drawings.

Hereinbelow, the best mode to carry out the present invention is described with reference to the attached drawings.

It should be noted that, although various limitations are made as a preferred specific example of the present invention in the embodiment described below, the present invention is not limited to these aspects. In addition, the description below exemplifies a case in which a filter and a metal plate member are applied as a filter for an ink jet recording apparatus (hereinbelow, abbreviated as a printer), which is a typical liquid ejecting apparatus. This filter captures foreign substances in the ink supplied to a pressure generation chamber of an ink ejecting head.

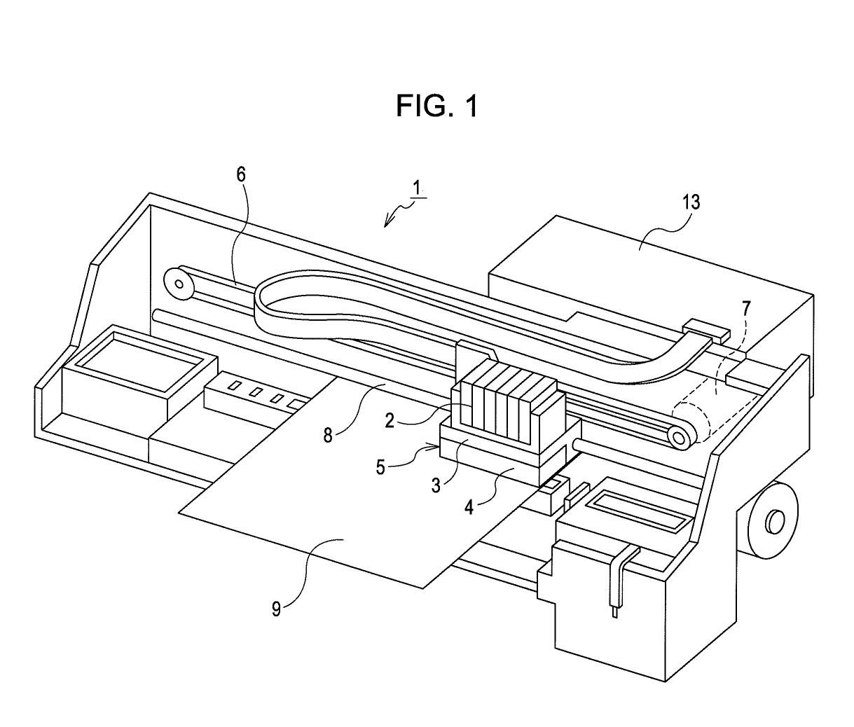

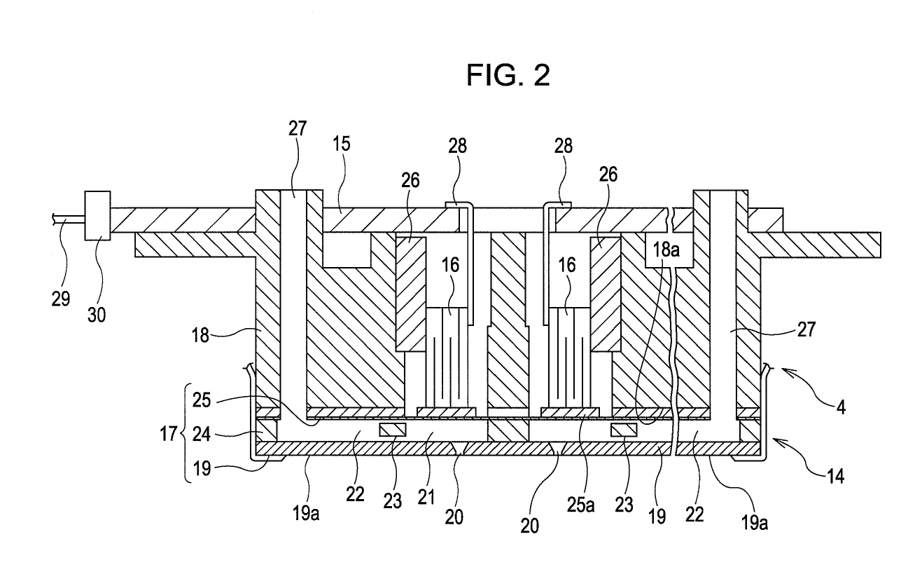

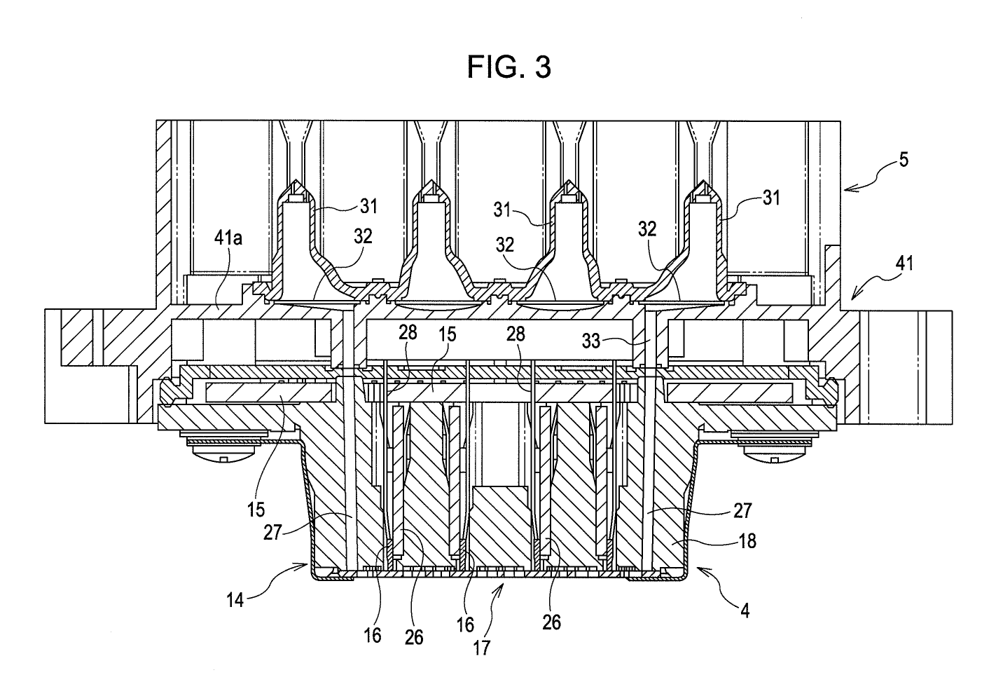

Here, FIG. 1 is a perspective view of the ink jet recording apparatus, FIG. 2 is a sectional view of the main portion of the ink ejecting head, and FIG. 3 is a sectional view of the entire ink ejecting head.

A printer 1 has an ink ejecting head 5 in which a carriage 3 having an ink cartridge 2 mounted therein, a recording head 4 installed in the carriage 3, and the like are integrated. The carriage 3 is connected via a timing belt 6 to a stepping motor 7 and is guided by a guide bar 8 to reciprocate in the widthwise sheet of a recording paper sheet 9 (in the main scanning direction). The carriage 3 is box shaped with an open top, and is installed so that the nozzle face of the recording head 4 is exposed at a side (underside) facing the recording paper sheet 9 and also contains the ink cartridge 2.

Ink is supplied from the ink cartridge 2 to the recording head 4 and ink droplets are discharged to the topside of the recording paper sheet 9 while the carriage 3 is being moved to print images and characters in a dot matrix.

The ink ejecting head 5 (refer to FIG. 1) is provided with a control plate member 15 as shown in FIG. 2, and an operation signal is inputted from a control apparatus 13 (refer to FIG. 1) via the control plate member 15 to piezoelectric oscillators 16 to be described later. The control plate member 15 is arranged on a head case 18 on the opposite side from a flow path unit 17.

The flow path unit 17 is arranged on the tip portion of the recording head 4 of the present embodiment, and the flow path unit 17 is provided with a nozzle plate 19 having nozzle openings 20 arranged on a nozzle formation surface 19a. In addition, pressure generation chambers 21 are provided in communication with the nozzle openings 20, ink is supplied from ink reservoir chambers 22 to the pressure generation chambers 21 and the ink is pressurized by the piezoelectric oscillators 16.

In other words, in the flow path unit 17, the following are laminated: a pressure generation chamber forming plate 24, in which spaces are formed corresponding to the nozzle plate 19 having the nozzle formation surface 19a with the nozzle openings 20 penetrated therethrough, the ink reservoir chambers 22, which are common liquid reservoir chambers for the pressure generation chambers 21, and ink supply paths 23 for communicating them, and a sealing plate, in other words, a diaphragm 25 for sealing the openings of the pressure generation chambers 21 and the ink reservoir chambers 22. Then, the nozzle formation surface 19a is a flat surface. It should be noted that the flow path unit 17 is joined to a tip surface 18a of the head case 18 using an adhesive.

The piezoelectric oscillators 16 are so-called vertical oscillation mode oscillators that contract longitudinally in a charged state due to an input of a drive signal and extend longitudinally in the process of discharging from the charged state. The piezoelectric oscillators 16 are in a state in which tip portions thereof are secured to island portions 25a of the diaphragm 25 forming a part of the pressure generation chambers 21 and other tip portions thereof are fixed to fixed plates 26. It should be noted that the vertical oscillation mode piezoelectric oscillators 16 can also be changed to flexural oscillation mode piezoelectric oscillators.

Head flow paths 27 are formed in the head case 18, and via the head flow paths 27, the ink in the ink cartridge 2 (refer to FIG. 1) is introduced into the ink reservoir chambers 22. Flexible cables 28 are connected to the piezoelectric oscillators 16 to which drive signals from the control plate member 15 are inputted. In addition, a flexible cable 29 that transmits an operation signal to the control plate member 15 from the control apparatus 13 (refer to FIG. 1) controlling the entire printer 1 (refer to FIG. 1) is connected via a terminal 30 to the control plate member 15.

In the recording head 4, the pressure generation chambers 21 expand and contract due to the contraction and extension of the piezoelectric oscillators 16, and suction of ink and discharge of ink droplets are carried out due to the pressure variation in the pressure generation chambers 21. In the nozzle plate 19, a plurality of nozzle pairs are formed where two rows as a pair. On the nozzle formation surface 19a, head covers 14 are provided for protecting the side edges.

The ink sent from the ink cartridge (refer to FIG. 1) flows into the ink reservoir chambers 22 from the head flow paths 27 and, after that, is pressurized in the pressure generation chambers 21 by the operation of the piezoelectric oscillators 16 to be discharged in a state of ink droplets from the nozzle openings 20 towards the recording paper sheet 9 (refer to FIG. 1) and thus printing progresses.

In a head holder 41 mounted in the carriage 3 (refer to FIG. 1), as shown in FIG. 3, the ink ejecting head 5 is configured in a state where the recording head 4 is combined therewith. A plate-shaped base member 41a is arranged in the upper portion of the head holder 41, and ink supply needles 31 that enter the ink cartridge 2 (refer to FIG. 1) are installed on the plate-shaped base member 41a. Internal pathways of the ink supply needles 31 communicate with introduction flow paths 33 via a filter 32, and the introduction flow paths 33 communicate with the head flow paths 27 via introduction tubes 34 provided under the plate-shaped base member 41a.

The filter 32 for this kind of printer 1 is configured for use with a metal plate member or a filter of the present invention.

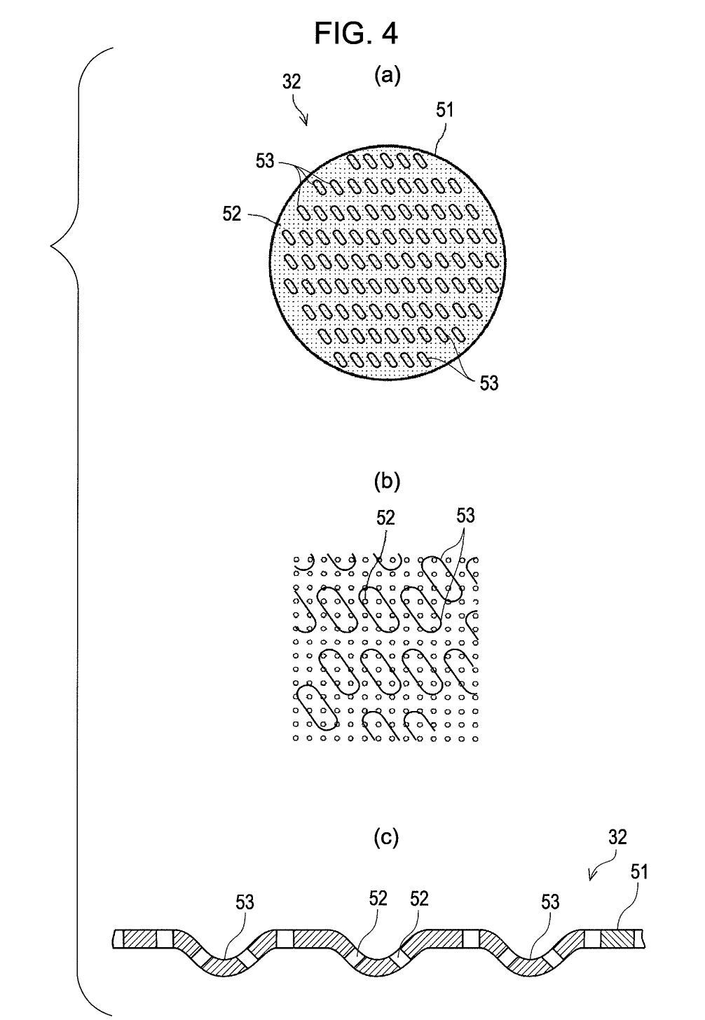

The filter 32 is, as shown in FIG. 4, configured by perforating minute holes 52, which are a large number of through bores (for example, tens of thousands of holes in 1 cm², the diameter or diagonal length of each hole being 15 μm), in a metal plate member 51 that is, for example, flat, extremely thin (for example, thickness of 15 μm), and made of stainless steel (made of SUS), and by cutting the outline in a circular shape, and has an outer diameter of, for example, approximately 8 to 9 mm. The size of minute holes 52, which are through bores, is determined to be smaller than the nozzle openings 20 (refer to FIG. 2) to function as the filter 32. It should be noted that the hole shape of the filter 32 is not limited to the case of a circular shape and can also be a polygonal shape, such as a square or a hexagon, where in the case of a circular shape, the diameter is determined to be smaller than the nozzle openings 20, and in the case of a polygonal shape, the diagonal length is determined to be smaller than the nozzle openings 20 of the printer 1 to function as a filter.

In addition as shown in FIG. 4, the metal plate member 51, which is a metal plate member and extremely thin, has a plurality of lines of unevenness 53 due to plastic deformation under pressure formed on the surface as pressure imprints by rolling spheres, and here the lines of unevenness 53 caused by the rolling of each sphere are formed in a zigzag arrangement in a length corresponding to the rolling distance. In this way, a multidirectional straightening force is exerted, with the rolling spheres due to the lines of unevenness 53 by rolling the large number of spheres arranged in zigzag, to the warping resulting from the residual stress when the large number of minute through holes 52 is perforated (bored) in the metal plate member 51 in order to correct into a flat state. Consequently, by making the unevenness height (depth) of the lines of unevenness 53 caused by the rolling spheres to be extremely small, the metal plate member 51 and the filter 32 can be flat even when the large number of lines of unevenness 53 arranged in zigzag is plastic deformed and left in a state left as pressure imprints, and even warping of the extremely thin filter 32 is corrected to maintain a flat state, and thus handling becomes easier and the productivity during assembly can be improved.

It should be noted that, in a case of employing the metal plate member 51 for the filter 32, it can be assembled even more simply by providing a flat flange portion, in the periphery of the installation area, for example, in which the lines of unevenness 53 are not formed.

Since the lines of unevenness 53 described above are formed on the thin metal plate member 51 due to plastic deformation under pressure, they are formed in pairs on the surfaces (a front side and a back side in a narrow sense) of the metal plate member 51.

In the metal plate member 51 and the filter 32, the pitch between adjacent minute holes 52 is determined to be, for example, approximately 45 μm, and the lines of unevenness 53 formed by rolling the spheres are determined to such a pitch as formed by spheres with diameters of 1 to 5 mm, the pitch between the spheres adjacent to each other, being, for example, approximately 1 to 10 mm, and are formed by rolling them in a state of being pressed to a certain depth.

By changing the height, pitch, and alignment of the lines of unevenness 53 of such a plurality of rolling spheres, the straightening force to be exerted to the metal plate member 51 and the filter 32 can be adjusted and multidirectionally exerted, and the warping may be corrected by determining and adjusting them so as to correspond to the degree of warping developed differently depending on the degree of processing of the metal plate member 51 and the filter 32 and the like.

In addition, by rolling the spheres, directionality of the straightening can be eliminated from ends of the lines of unevenness 53 in the direction in which the spheres are rolled, and the straightening force can be exerted uniformly to the metal plate member 51 and the filter 32. Consequently, without performing straightening in another intersecting direction as with a roller leveler, the warping generated in the metal plate member 51 can be corrected in one step.

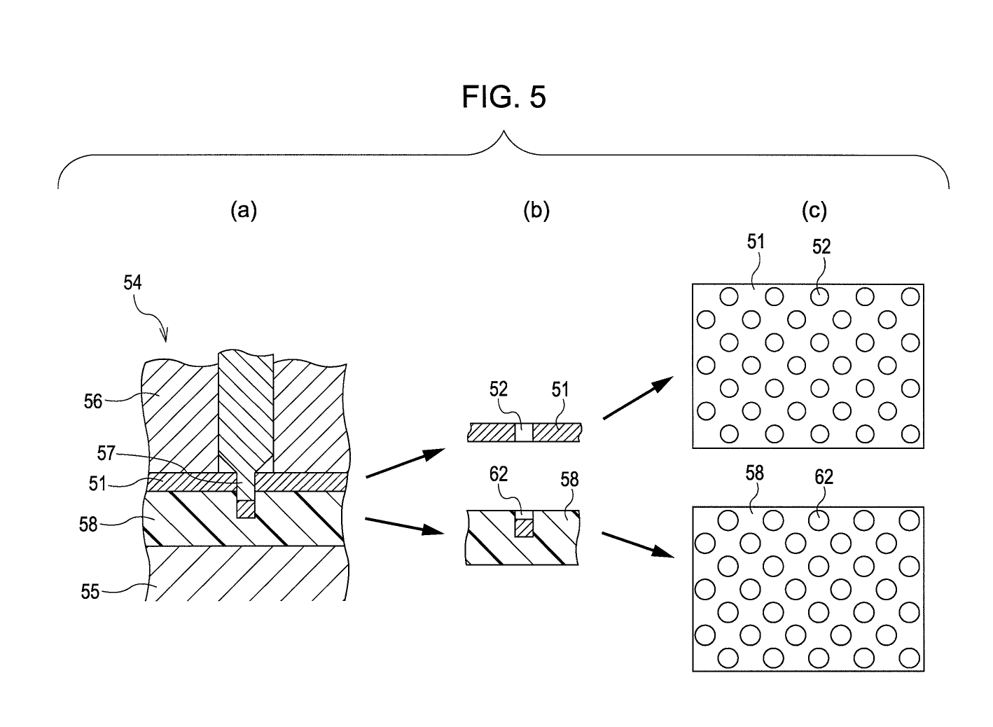

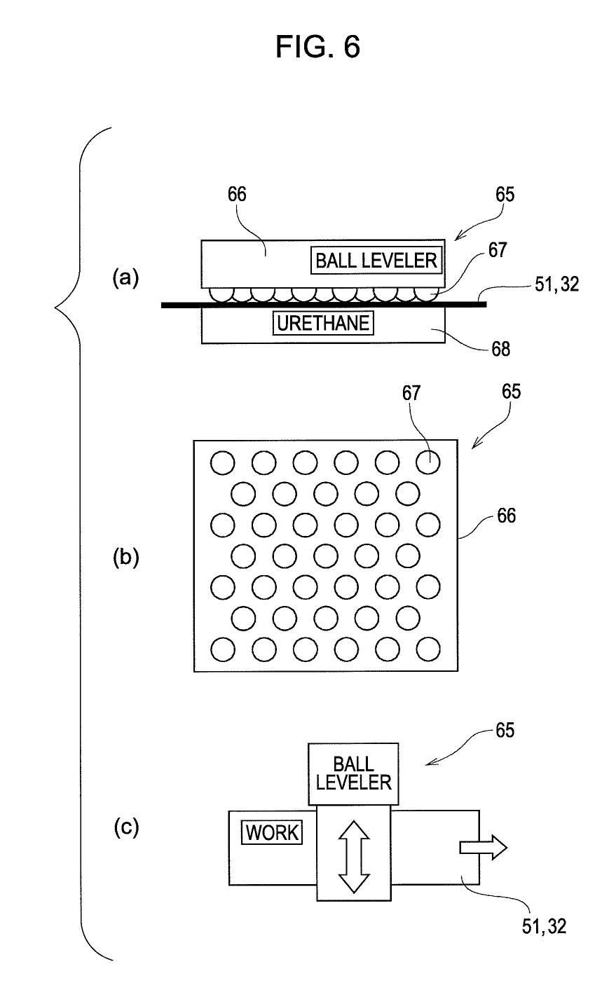

Next, a case in which a method of manufacturing the metal plate member of the present invention is applied to filter processing is described based on FIGS. 5 to 6.

Firstly, in order to perforate a large number of the minute through holes 52 in the metal plate member 51 to be a metal plate member, punching processing is carried out by a pressing apparatus. For this reason, the pressing apparatus 54 is, as shown in FIG. 5(a), equipped with a flat board shaped foundation 55 on which unevenness is not formed, and facing to the topside, a punch 57 is provided via a stripper 56. On the topside of the flat board shaped foundation (receiving base) 55, a mat-like soft member made of, for example, PET (polyethylene terephthalate: a polymeric material) or the like is provided as an elastic mat 58, and the metal plate member 51 is set on the elastic mat 58. A tip portion of the punch 57 is, for example, cylindrically shaped, and the diameter thereof corresponds to the diameter of the minute holes 52 in the filter 32, and by pressing the punch 57, the tip of the punch 57 is inserted into the elastic mat 58. In this way, as shown in FIGS. 5 (b) and (c), a large number of punched pieces 62 of the metal plate member 51 can be pushed into the elastic mat 58 and held as they are, and the minute holes 52 can be punched with dieless processing. In addition, since the surface of the elastic mat 58 on the foundation 55 is flat without unevenness, the amount of pushing of the punch 57 can be uniform, and the large number of punched pieces 62 can with certainty be kept inside the elastic mat 58.

It should be noted that the elastic mat 58 is not limited to PET, and for example, it is also possible to use other polymeric materials and the like, such as PC (polycarbonate), POM (polyacetal), ABS (ABS resin), and PPS (polyphenyne sulfide), and any of various hardnesses can be selected in accordance with the thickness of the metal plate member, the size and pitch of the minute holes, and the like.

The thickness of the elastic mat 58 is to be at least twice the thickness of the metal plate member 51, and since the thickness of the metal plate member 51 is to be 0.01 to 0.5 mm, it is to be approximately 0.02 to 1.0 mm.

Herein, by making the elastic mat 58 approximately 0.1 to 0.2 mm thick, the punched pieces 62 can with certainty be kept inside the elastic mat 58 without making the thickness unnecessarily large, and also the minute holes 52, which are complete through bores, can be formed in the metal plate member 51, and thus generation of burrs due to perforation failure and the like, can be suppressed, around the edges of the minute holes 52. Because of this, position alignment between the foundation 55 and the tip of the punch 57 becomes unnecessary, and the metal plate member 51 and the filter 32 with the minute holes 52 formed therethrough can easily be processed.

In an actual punching step, after punching the minute holes 52 by pressing the tip of the punch 57 into the metal plate member 51, in a state where the stripper 56 is raised and the punched pieces 62 are kept in the elastic mat 58, the large number of minute holes 52 are formed by repeatedly moving the metal plate member 51 by one pitch together with the elastic mat 58 and again punching the tip of the punch 57 through the metal plate member 51.

In such a way, by repeatedly moving the metal plate member 51 by one pitch together with the elastic mat 58 and performing punching with the punch 57, there is absolutely no possibility of generating lateral burrs, but even if a burr was generated, it would be crushed by the board side of the stripper 56, and the minute holes 52 are not deformed. It should be noted that, according to an experiment, it was confirmed that the punch 57 was negligibly damaged although burrs of approximately 4 μm to 5 μm were generated in a case of using PET as the elastic mat 58. In addition, it was also confirmed that burrs can be made smaller by using a harder soft member.

Since warping is generated in the metal plate member 51 with the large number of minute through holes 52 thus formed therethrough while processing the holes, a process for warping correction is carried out. This correction of warping of the metal plate member 51 is carried out with a ball type leveler by forming the plurality of lines of unevenness 53 made by rolling the spheres on a surface of the metal plate member 51 in a state of plastic deformation as pressure imprints.

For this straightening process, as shown in FIG. 6, a ball leveler 65 is used in which balls are arranged in zigzag, and with a leveler main body 66, as shown in FIGS. 6 (a) and (b), convex pressing portions 67 are provided in which spheres protruding from the surface are arranged in zigzag and held rotatably, and an elastic body 68 is provided that supports the metal plate member 51 facing the leveler main body 66 and for which an urethane made elastic mat, for example, is used. The spheres of the convex pressing portions 67 have diameters of 1 to 5 mm and adjacent intervals of the zigzag formation, in other words, a pitch is 1 to 10 mm, for example.

It should be noted that, since the straightening force to be exerted to the metal plate member 51 and the filter 32 can be adjusted in accordance with the diameter and alignment pitch of the spheres of the convex pressing portions 67, warping may be corrected by determining and adjusting so as to corresponds to the degree of warping developed differently according to the degree of processing to the metal plate member 51 and the filter 32 and the like, and it is possible to densely align a large number of spheres and also configure the spheres in one row or in a plurality of rows.

By setting the metal plate member 51 between such convex pressing portions 67 and the elastic body 68 with the elastic mat and by pressing it with the convex pressing portions 67 and also by relatively moving the convex pressing portions 67 and the metal plate member 51 so as to roll the spheres, the lines of unevenness 53 are plastic processed with press marks by rolling the spheres, the straightening force can be exerted uniformly and multidirectionally to the metal plate member 51 and the filter 32 on the tip surface in the sphere rolling direction, and warping generated in the metal plate member 51 can be corrected by one straightening process.

In the straightening process in which the convex pressing portions 67 and the metal plate member 51 are relatively moved so as to roll the spheres, as shown in FIG. 6 (c) for example, by reciprocating the convex pressing portions 67, while transporting the metal plate member 51, in the widthwise direction of the metal plate member 51 orthogonal to the transporting direction, the lines of unevenness 53 (the lines of unevenness 53 consecutive in zigzag) are formed, as shown in FIGS. 4 (a), (b), in a state of rolling the spheres relatively obliquely, and thereby the metal plate member 51 can be straightened to be flat.

It should be noted that, by using the spheres aligned in zigzag for the convex pressing portions 67, it becomes possible to perform straightening across the full width of the metal plate member 51 while making the moving distance of the convex pressing portions 67 short. In addition, a configuration also may be made in which at least one row of spheres is arranged perpendicular to the direction of movement of the convex pressing members 67 and supported rollably, and in this case, by making the moving distance (rolling distance) longer, the metal plate member 51 can be straightened across the full width thereof.

In a case of making such a metal plate member 51 serve as the filter 32, by making the periphery that is to serve as the installation area, for example, to be an unprocessed flat flange portion on which the lines of unevenness 53 are not formed, it can be a filter that is simply installed in the liquid flow path and filters the liquid in the liquid flow path. In the printer 1 for example, it can be used as the filter 32 for the ink ejecting head that captures foreign substances in the ink supplied to the pressure generation chambers 21 of the ink ejecting head 5 having the pressure generation chambers 21 and the nozzle openings 20.

It should be noted that, although spheres made of metal are used as the convex pressing portions 67 of the leveler main body 66 of the ball leveler 65 by being arranged in zigzag in order to correct the warping of the metal plate member 51 with the plurality of minute through holes 52 perforated therethrough in the method of manufacturing a metal plate member described above, the spheres also can be configured with resin materials and, since softer than a metal member, concentration of stress due to the straightening process can be prevented and warping can be corrected.

By the way, the present invention is not limited to the above embodiment but can variously be modified on the basis of the description of the scope of the patent claims.

In addition, the metal plate member (a metal substrate) of the present invention is not limited to the case of being used as a filter for filtering a liquid in a liquid flow path, but can be widely applied to metal plate members used with a plurality of through bores perforated therethrough and subjected to warping correction in a case that warping due to bore processing is generated, and also can be widely applied as a method of processing the same.

1. a metal plate member, having a plurality of through bores perforated therethrough,
wherein pressure imprints are formed by pressing a pressing member against a surface of the metal plate member.

2. The metal plate member according to claim 1,
wherein the pressure imprints are lines of unevenness and are formed in pairs on front and back sides of the metal plate member.

3. A filter disposed in a liquid flow path and filtering a liquid in the liquid flow path, comprising:
pressure imprints formed by pressing, with a pressing member, and subjecting to plastic deformation under pressure a surface of a metal plate member with a plurality of through bores perforated therethrough.

4. The pressure imprints are lines of unevenness and are formed in pairs on front and back sides of the metal plate member.

5. A liquid ejecting head, comprising the filter according to claim 1.

6. A liquid ejecting apparatus, comprising the liquid ejecting head according to claim 5.

7. A method of manufacturing a metal plate member with a plurality of through bores perforated therethrough, comprising:
setting the metal plate member between a leveler main body equipped with a plurality of convex pressing portions to which spheres protruding from a surface thereof are rollably provided and an elastic body supporting the metal plate member; and
forming pressure imprints on a surface of the metal plate member by pressing the leveler main body towards the metal plate member in such state and also by moving relative to the metal plate member.

8. The manufacturing method according to claim 7, wherein the spheres are configured with a resin member.

9. The manufacturing method according to claim 8, wherein the pressure imprints are formed by exerting a multidirectional straightening force by rolling of the spheres.
